(19) United States
(12) Patent Application Publication
(10) Pub. No.: US 2009/0296400 A1
(43) Pub. Date: Dec. 3, 2009

(54) HIGH-PRESSURE MERCURY LAMP, LAMP UNIT, AND IMAGE DISPLAY APPARATUS

(76) Inventors: Masaru Ikeda, Osaka (JP); Shunsuke Ono, Osaka (JP); Minoru Ozasa, Kyoto (JP); Masahiro Yamamoto, Osaka (JP); Tsuyoshi Nagakura, Tokushima (JP)

Correspondence Address: SNELL & WILMER L.L.P. (Panasonic), 600 ANTON BOULEVARD, SUITE 1400, COSTA MESA, CA, 92626, US

(21) Appl. No.: 11/719,804

(22) PCT Filed: Dec. 14, 2005
(86) PCT No.: PCT/JP05/23436

§ 371 Date: Apr. 2, 2009

(30) Foreign Application Priority Data
Dec. 17, 2004 (JP) 2004-366748

(51) Int. Cl. H01J 61/36; F21V 7/00

(52) U.S. Cl. 362/263; 313/623

(57) ABSTRACT

A high-pressure mercury lamp including electrode assemblies and a discharge vessel (23) that is composed of: a main tube part (15) having a discharge space (13) inside; and a sealing part (17) connected to the main tube part. The electrode assemblies extend into the discharge space from and are hermetically sealed with the sealing part such that their tips face each other in the discharge space. The discharge space (13) is filled with mercury as light-emitting material, rare gas such as xenon, and halogen gas for halogen cycle. An electrode assembly is composed of an electrode part (27a), a metal foil (29a), and an external lead. The base part of an electrode inside the discharge space is provided with a liquid collecting coil (43) for holding mercury that gathers around the base part during a cooling period while lighting is off.

### TECHNICAL FIELD

The present invention relates to a high-pressure mercury lamp, a lamp unit using the high-pressure mercury lamp, and an image display apparatus.

### BACKGROUND ART

In a high-pressure mercury lamp, a pair of electrodes extend into a discharge space filled with mercury such that the tips of the electrodes face each other with a distance in between. The lamp is lighted by causing an arc discharge to occur between the pair of electrodes. Hereinafter, the arc discharge occurring between the tips of electrodes is referred to as “main discharge”.

In such a high-pressure mercury lamp, the main discharge does not occur at first between the pair of electrodes, but first a discharge occurs at the base of an electrode in the discharge space (hereinafter merely referred to as “electrode base part”) and it changes into the main discharge when the temperature in the discharge space increases and the mercury vapor pressure (gas vapor pressure) increases enough.

The discharge that occurs at the base of an electrode is referred to as “base discharge”. The base discharge transfers to the base of the other electrode along the inner surface of the discharge vessel forming the discharge space, as a chain reaction of creeping discharges occurs via the conductors such as mercury that are attached to the inner surface. The base discharge occurs because the temperature in the discharge space and the mercury vapor pressure between the tips of the electrodes are both low at the start of the lighting.

After the base discharge occurs, the base of the electrode becomes an arc spot. The arc spot causes the material (tungsten) of the electrode to evaporate. The evaporated material attaches to and accumulates on the inner surface of the discharge vessel. The accumulation is called “blackening phenomenon”. The more the time between the base and main discharges, the more the amount of the accumulated material. The accumulation leads to a short life of the lamp due to reduction in the luminous flux maintenance factor.

Japanese Laid-Open Patent Application No. 10-188896, for example, discloses a technology for improving the base discharge. According to the technology, a heat-keeping film is provided on an outer surface of the discharge vessel at a position corresponding to the electrode base part in the discharge space to keep the heat while the lamp is off. This construction is aimed to prevent the base discharge from occurring at the start of the lighting by preventing the metal halide from gathering at the electrode base part.

However, as explained above, the base discharge occurs because the temperature in the discharge space and the mercury vapor pressure (gas vapor pressure) between the tips of the electrodes are both low. Accordingly, the above-mentioned technology of the Japanese laid-open patent application only produces an effect not enough to prevent the base discharge from occurring, and it takes time for the base discharge to change into the main discharge. The disclosed heat-keeping film is, effective only after the temperature starts to increase, but is not effective when the discharge vessel has been completely cooled while the lamp has been off for a long time period, because it takes time for the base discharge to change into the main discharge.

### DISCLOSURE OF THE INVENTION

It is an object of the present invention to provide a high-pressure mercury lamp, a lamp unit using the high-pressure mercury lamp, and an image display apparatus that can extend the life of the lamp by reducing the effect of the blackening phenomenon caused by the base discharge.

The above object is achieved by a high-pressure mercury lamp, comprising: a discharge vessel composed of a main body and a sealing part connected to the main body, the main body having inside a discharge space filled with mercury; two electrodes that respectively extend into the discharge space from and are supported by the sealing part such that tips thereof face each other in the discharge space; and a holding member operable to hold mercury that gathers, during a cooling period while lighting is off, in vicinities of base parts of the electrodes inside the discharge space.

With the above-stated construction, the mercury, which gathers in the vicinities of base parts of the electrodes inside the discharge space during a cooling period while lighting is off, is held there. As a result, when the lamp is turned on and the base discharge occurs at the base part of an electrode, the temperature at the base part increases and a large amount of mercury held at the base part is evaporated quickly. This causes the base discharge to change into the main discharge quickly (decreases the time required for the transition from the base discharge to the main discharge). This prevents the blackening phenomenon from occurring and achieves a long life of the lamp.

It should be noted here that “vicinities of base parts of the electrodes” indicate such areas in which mercury is evaporated by the heat that is generated by the base discharge that occurs at the start of the lamp lighting.

Also, the “high-pressure mercury lamp” here includes many types such as: a type in which a pair of electrodes respectively extend from the sealing parts into the discharge space substantially in a straight line; and a type in which a pair of electrodes extend substantially in parallel with each other from a sealing part and the tips thereof are bent to face each other in the discharge space substantially in a straight line. Therefore the “high-pressure mercury lamp” here is not limited to a certain type based on the direction in which the electrodes extend from the sealing part or based on whether it has a bent part or not.

In the above-described high-pressure mercury lamp, the holding member may be fixed to the base parts of the electrodes.

With the above-stated construction, the mercury, which gathers in the vicinities of base parts of the electrodes during a cooling period while lighting is off, is held there efficiently.

In the above-described high-pressure mercury lamp, the holding member maybe a liquid collecting member operable to collect liquefied mercury which is generated as mercury vapor accumulates and is liquefied at the base parts.

With the above-stated construction, the liquefied mercury, which is generated as the mercury vapor accumulates and is cooled in the vicinities of base parts of the electrodes in the discharge space during a cooling period-while lighting is off, is held by the liquid collecting member. As a result, when the lamp is turned on and the base discharge occurs at the base part of an electrode, the temperature at the base part increases and a large amount of mercury held at the base part is evaporated quickly.

In the above-described high-pressure mercury lamp, the liquid collecting member may be made by winding a wire to have one or more turns.

In the above-described high-pressure mercury lamp, each electrode may include an electrode rod and an electrode coil that is provided at a tip of the electrode, and the liquid collecting member may be provided on the electrode rod.

In the above-described high-pressure mercury lamp, the liquid collecting member may be provided separately from the electrode coil.

The above object is also achieved by a high-pressure mercury lamp, comprising: a discharge vessel composed of a main body and a sealing part connected to the main body, the main body having inside a discharge space filled with mercury; and two electrodes that respectively extend into the discharge space from and are supported by the sealing part such that tips thereof face each other in the discharge space, wherein base parts of the electrodes inside the discharge space have an area expansion part that has an increased area of a surface of the electrodes to which mercury is attached during a cooling period while lighting is off.

With the above-stated construction, a large amount of liquefied mercury, which is generated as the mercury vapor accumulates and is cooled in the vicinities of base parts of the electrodes in the discharge space during a cooling period while lighting is off, attaches to the area expansion part. As a result, when the lamp is turned on and the base discharge occurs at the base part of an electrode, the temperature at the base part increases and a large amount of mercury attached to the area expansion part at the base part is evaporated quickly.

It should be noted here that “vicinities of base parts of the electrodes” indicate such areas in which mercury is evaporated by the heat that is generated by the base discharge that occurs at the start of the lamp lighting.

The above object is also achieved by a lamp unit, comprising: the high-pressure mercury lamp defined in Claim 1; and a reflecting mirror that reflects light emitted from the high-pressure mercury lamp.

With the above-stated construction, the lamp unit ensures a long life of a lamp since the lamp unit includes the above-described high-pressure mercury lamp.

The above object is also achieved by an image display apparatus comprising the high-pressure mercury lamp defined in Claim 1.

With the above-stated construction, the image display apparatus ensures a long life of a lamp since the image display apparatus includes the above-described high-pressure mercury lamp.

### BRIEF DESCRIPTION OF THE DRAWING

FIG. 1 is a cutaway perspective view of a lamp unit of an embodiment of the present invention.

FIG. 2 is a plan view of the lamp unit, where the reflecting mirror is partially cut away to provide an inner view of the lamp.

FIG. 3 is an enlarged view of an electrode base part.

FIG. 4 shows the measurement results of base discharge duration for different constructions.

FIG. 5 is a cutaway perspective view of a liquid crystal projector of Embodiment 2.

FIG. 6 is a perspective view of a back-projection type image display apparatus as a modification to Embodiment 2.

FIG. 7 shows a modification to the liquid collecting member.

FIG. 8 shows a lamp that is different from the lamp of the embodiments in the direction in which the electrodes extend.

### BEST MODE FOR CARRYING OUT THE INVENTION

### Embodiment 1

The following describes Embodiment 1 of the present invention that relates to a lamp unit using a high-pressure mercury lamp, with reference to the attached figures.

### 1. Construction of Lamp Unit

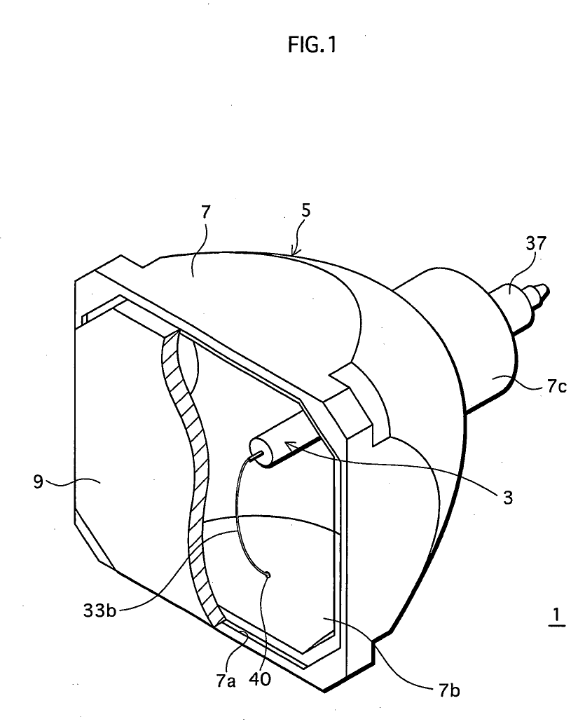

FIG. 1 is a perspective view of a lamp unit of the present embodiment.

As shown in FIG. 1, a lamp unit 1 includes a high-pressure mercury lamp (hereinafter merely referred to as “lamp”) 3 and a reflecting mirror 5. The lamp 3 is provided in the reflecting mirror 5. The reflecting mirror 5 includes a reflecting member 7 and a glass member 9.

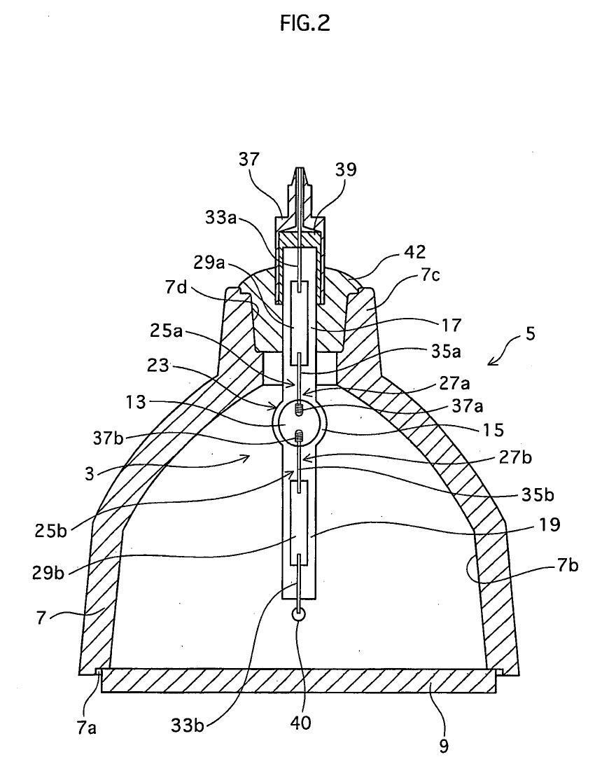

FIG. 2 is a plan view of the lamp unit, where the reflecting mirror is partially cut away to provide an inner view of the lamp.

As shown in FIG. 2, the lamp 3 includes a discharge vessel 23 and electrode assemblies 25a and 25b. The discharge vessel 23 is composed of a main tube part (corresponding to “main body” in the claims) 15, which has a discharge space 13 therein, and two sealing parts 17 and 19 provided on opposite sides of the main tube part 15. The electrode assemblies 25a and 25b are respectively hermetically sealed with the sealing parts 17 and 19 such that the tips (electrode parts which will be described later) of the electrodes face each other with a distance in between in the discharge space 13. The discharge space 13 is filled with mercury as a light-emitting material, a rare gas, and a halogen gas for halogen cycle.

The electrode assembly 25a is composed of an electrode part 27a, a metal foil 29a, and an external lead 33a which are connected (and fixed by, for example, welding) to one another in the stated order. Similarly, the electrode assembly 25b is composed of an electrode part 27b, a metal foil 29b, and an external lead 33b which are connected (and fixed by, for example, welding) to one another in the stated order. It should be noted here that the tips of the electrode assemblies 25a and 25b are the electrode parts 27a and 27b, and that the electrode parts 27a and 27b correspond to “electrodes” in the claims).

The external leads 33a and 33b extend to outside of the discharge vessel 23 from the outer ends of the sealing parts 17 and 19, respectively. The external lead 33b passes through a through hole 40 formed in the reflecting member 7 and extends to outside of the reflecting mirror 5, as shown in FIGS. 1 and 2.

The electrode parts 27a and 27b are disposed to align substantially in a straight line to face each other in the discharge space 13. In the case of a lamp that is used for a projection-type image display apparatus (what is called “short-arc” type lamp), the distance between the electrode parts 27a and 27b, namely the inter-electrode distance is set to a range from 0.5 mm to 2.0 mm so that the light source provided between the electrode parts 27a and 27b is close to the point light source.

The electrode part 27a includes an electrode rod 35a and an electrode coil 37a that is wound around the electrode rod 35a at the tip thereof; and the electrode part 27b includes an electrode rod 35b and an electrode coil 37b that is wound around the electrode rod 35b at the tip thereof. It should be noted here that the electrode rods and the electrode coils may be made from the same material or from different materials.

The electrode assemblies 25a and 25b (mainly the metal foils 29a and 29b thereof) are hermetically sealed to the sealing parts 17 and 19 respectively such that the electrode coils 37a and 37b have a predetermined distance in between. With this sealing, the discharge space 13 is formed in the main tube part 15, and as shown in FIG. 2, the electrode parts 27a and 27b extend into the discharge space 13 from the sealing parts 17 and 19, respectively.

Here, parts of the electrode parts 27a and 27b that are exposed to the discharge space 13 and near the sealing parts 17 and 19 respectively are referred to as “base parts of the electrode parts 27a and 27b”, “electrode base parts”, or “base parts of the electrode rods 35a and 35b”, where these base parts all correspond to “base parts of the electrodes” in the claims.

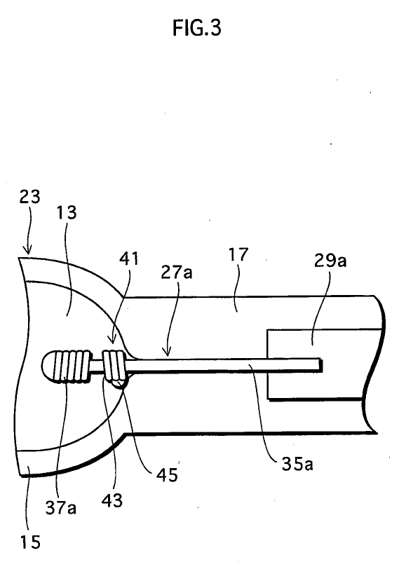

FIG. 3 is an enlarged view of a base part of an electrode and its vicinity. It should be noted here that although FIG. 3 shows the electrode part 27a, the other electrode part 27b also has the same construction.

A liquid collecting member 41 for collecting liquefied mercury is provided at each base part of the electrode parts 27a and 27b, where the liquefied mercury is generated as the mercury vapor accumulates at the base part and is cooled while the lamp is off. The liquid collecting member 41 is, in the present embodiment, a coil 43 that is made by winding a wire to have a plurality of turns (in the present embodiment, substantially three turns). It should be noted here that the coil 43 is hereinafter referred to as liquid collecting coil 43.

The liquid collecting coil 43 is formed of a wire that is made of the same material as the electrode rods 35a and 35b. The liquid collecting coil 43 is fixed to each of the electrode rods 35a and 35b by directly winding a wire around the electrode rods 35a and 35b or by welding a coil, which has been wound already, to the electrode rods 35a and 35b.

The electrode parts 27a and 27b (namely the base parts thereof) are connected to external units via the metal foils 29a and 29b and the external leads 33a and 33b. Since they are made of materials having high thermal conductivity, the base parts have the lowest temperature among the portions within the discharge space 13 during a cooling period while the lamp is off, which causes mercury to gather at the electrode base parts.

Back to FIG. 2, a base 37 is fixed to the outer end of the sealing part 17 via cement 39 so as to cover the outer end, and the external lead 33a is connected to the base 37. It should be noted here that the base is fixed to any one of the two outer ends of the sealing parts.

As shown in FIGS. 1 and 2, the reflecting mirror 5 includes the reflecting member 7 and the glass member 9. The reflecting member 7 includes a reflecting surface 7b being a concave surface, and the glass member 9 closes an opening 7a of the reflecting member 7. The glass member 9 is bonded with the reflecting member 7 by, for example, a silicon-based adhesive.

The reflecting member 7 is, for example, a reflecting mirror whose inner surface is the reflecting surface 7b, such as a dichroic reflecting mirror. The reflecting member 7 reflects light, which comes from the main tube part 15 of the lamp 3, in a predetermined direction (toward the glass member 9) . The reflecting member 7 is in a shape of a funnel. As shown in FIG. 2, a through hole 7d is formed in a part (hereinafter referred to as “base part of the reflecting member”) 7c where the opening diameter is smaller than other portions of the reflecting member 7. The sealing part 17 of the lamp 3 passes through the through hole 7d.

As shown in FIG. 2, the lamp 3 is fixed to the reflecting mirror 5 by, for example, cement 42 while the sealing part 17, to which the base 37 has been fixed, is partially inserted in the through hole 7d of the base part 7c of the reflecting member 7.

### 2. Acts

In the lamp 3 having the above-described construction, the mercury vapor accumulates in an area where the temperature falls first during the cooling period while the lamp is off, then attaches to the liquid collecting coil 43. And as the temperature further decreases, the mercury vapor is liquefied and the liquefied mercury is collected by the liquid collecting coil 43. The liquefied mercury attaches to the surface of the liquid collecting coil 43 by surface tension, or enters the spaces between the liquid collecting coil 43 and the electrode rods 35a and 35b, or enters spaces between the three turns of wire of the liquid collecting coil 43 by capillary phenomenon, and the liquefied mercury is stored in these places.

The base discharge occurs even in the lamp 3 of the present invention when the lamp is lighted, and the base parts of the electrode parts 27a and 27b become arc spots and temperature rises there. On the other hand, more amount of mercury is present in the vicinities of the base parts of the electrode parts 27a and 27b, stored in the liquid collecting coil 43, in the lamp 3 of the present invention than in conventional lamps.

Accordingly, as the temperature rises at the base parts of the electrode parts 27a and 27b, a large amount of mercury that is present (stored) in the vicinities of the base parts is evaporated, and the mercury vapor pressure in the discharge space 13 increases.

The increase in the mercury vapor pressure increases in particular the density of mercury gas particles between the tips of the electrode parts 27a and 27b. This shortens mean free path of electrons emitted from the electrode parts 27a and 27b. When this happens, a discharge with a long discharge path, namely the base discharge cannot be maintained, and the base discharge quickly changes into the main discharge that has a short discharge path.

With such a construction, the electrode base parts become arc spots only for a short period in time. This results in the reduction of the material that is evaporated from the electrode base parts. This prevents the blackening phenomenon from occurring, and achieves a long life of the lamp 3.

### EXAMPLES

The following describes examples of the lamp having the above-described construction.

Here, a high-pressure mercury lamp of 270 W type being a high-output type is used.

The discharge vessel 23 is formed of quartz glass. Not limited to quartz glass, the discharge vessel may be formed of, for example, translucent ceramic.

The measurement of the discharge vessel 23 is as follows. The outer diameter of the main tube part 15 is 13 mm, the outer diameter of the sealing parts 17 and 19 is 7 mm, and a total length of the discharge vessel 23, a total length the main tube part 15 and the sealing parts 17 and 19, is 70 mm.

The discharge space 13 in the main tube part 15 is 250 mm³ in volume. The discharge space 13 contains 0.22 mg/mm³ (namely 55 mg) of mercury. The discharge space 13 also contains xenon, argon, and krypton as rare gases, where xenon is 1.5 atm and argon is 0.2 atm.

Also, as halogen gas, bromine is filled in the discharge space with 10⁻⁷ (μ mol/mm³) to 10⁻² (μ mol/mm³).

The electrode assemblies 25a and 25b, that is to say, the electrode parts 27a and 27b are made from a tungsten material. Also, the metal foils 29a and 29b and the external leads 33a and 33b are made from amolybdenum material. The electrode assemblies 25a and 25b are hermetically sealed to the sealing parts 17 and 19 respectively such that the distance between the electrode parts 27a and 27b is 1.5 mm. This is because the present lamp is the short-arc type.

The electrode rods 35a and 35b are 0.425 mm in diameter. The liquid collecting coils 43 are provided on the electrode rods 35a and 35b at positions that are respectively 0.5 mm away from the inner ends of the sealing parts 17 and 19 toward the electrode coils 37a and 37b, respectively.

The liquid collecting coil 43 is formed of a tungsten wire that is 0.06 mm in diameter, and has three turns at a pitch of 0.1 mm. The liquid collecting coil 43 is approximately 0.545 mm in outer diameter.

It should be noted here that although the examples of the lamp of the present embodiment are 270 W-type, other output types may be used, and that the present invention is not limited to the values provided in the present embodiment.

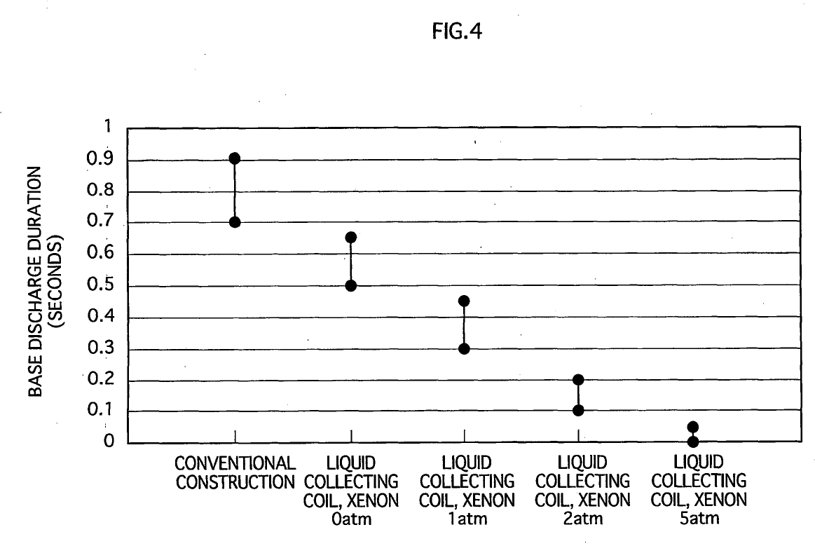

An experiment was conducted to measure the base discharge duration for lamp samples that were manufactured based on the lamp of the above-described embodiment to be different in the lamp construction. FIG. 4 shows the measurement results of base discharge duration.

It should be noted here that “conventional construction” in FIG. 4 indicates a lamp that lacks the liquid collecting coil 43 but is the same as the lamp 3 of the present embodiment otherwise. Also, “liquid collecting coil” in FIG. 4 indicates a lamp of the present embodiment that is provided with the liquid collecting coil 43. Five samples per lamp type were subjected to the experiment.

It is understood from FIG. 4 by comparing the conventional construction lamp with the lamp with the liquid collecting coil 43 that the base discharge continues 0.5 to 0.66 seconds in the lamp with the liquid collecting coil 43, while the base discharge continues for 0.7 to 0.9 seconds in the conventional construction lamp. That is to say, clearly the base discharge duration is shorter in the lamp with the liquid collecting coil 43 than in the conventional construction lamp, and thus the base discharge changes into the main discharge more quickly in the lamp with the liquid collecting coil 43 than in the conventional construction lamp. The reason for this has been discussed earlier.

Further, the lamp with the liquid collecting coil in the discharge space was subjected to another experiment in which xenon filling pressure in the discharge space 13 was varied to 0 atm, 1 atm, 2 atm, and 5 atm. FIG. 4 also shows the measurement results of this experiment.

It is apparent from FIG. 4 that there is a tendency that the higher the filling pressure of xenon is, the shorter the base discharge duration, and thus the time required for the transition from the base discharge to the main discharge, is. When the filling pressure of xenon is as high as 5 atm, there is hardly the base discharge duration.

As described above, when xenon is filled in the discharge space, the time required for the transition from the base discharge to the main discharge is reduced. There as on for this is as follows. Xenon has a larger atomic radius than argon (xenon has atomic radius 1.2 times that of argon) . As a result, the discharge space filled with xenon and argon is smaller than the discharge space filled with only argon in the mean free path of electrons emitted from the electrode parts 27a and 27b. Accordingly, in the discharge space filled with xenon and argon, a discharge with a long discharge path is maintained for a shorter time period than in the discharge space filled with only argon. It is considered from this point of view that filling a rare gas having a larger atomic radius in the discharge space would restrict the occurrence of the base discharge.

The process for filling xenon can be easily performed with the filling pressure ranging from 1 atm to 2 atm. In particular, the process for filling xenon can be easily performed for the filling pressure of 1.5 atm. With the filling pressure of 1.5 atm, the base discharge duration of the present invention example is one thirds of that of the conventional construction lamp.

### Embodiment 2

The following describes a front-projection type image display apparatus (hereinafter referred to as “liquid crystal projector”) that uses the lamp unit of Embodiment 1,with reference to the attached figures.

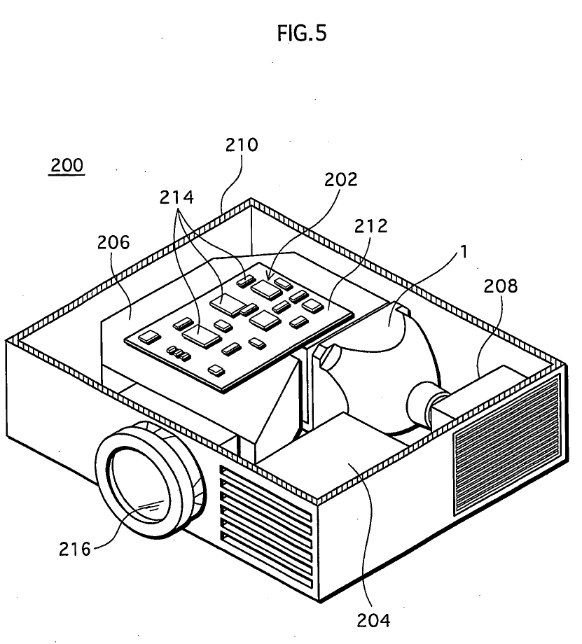

FIG. 5 is a cutaway perspective view of a liquid crystal projector of Embodiment 2.

As shown in FIG. 5, a liquid crystal projector 200 includes: the lamp unit 1 that includes the lamp 3; a power unit 202 that includes an electronic ballast for lighting the lamp 3; a control unit 204; a lens unit 206 in which a converging lens, a translucent color liquid crystal display plate, and a driving motor are embedded; a fan apparatus 208 for cooling; and a case 210 that houses these components. It should be noted here that the lens unit 206 is arranged such that part of it extends to outside of the case 210.

The power unit 202 generates a predetermined direct-current voltage from a 100V home alternating-current power supply, and supplies the generated direct-current voltage to the electronic ballast, the control unit 204, and the like. The power unit 202 includes: a board 212 disposed on the lens unit 206; and a plurality of electronic/electric components 214 mounted on the board 212.

The control unit 204 drives the color liquid crystal display plate so as to display a color image based on the image signals input from outside. The control unit 204 also controls the driving motor in the lens unit 206 so as to perform a focusing operation and a zooming operation.

The light beams emitted from the lamp unit 1 are converged by the converging lens and pass through the color liquid crystal display plate disposed in the light path. With this operation, an image formed on the color liquid crystal display plate is projected onto a screen (not illustrated) via the lens 216 and the like.

In regards with the liquid crystal projector 200 having the above-described construction, the lamp in the lamp unit 1, as explained in Embodiment 1, has a longer life than conventional lamps, and therefore, it provides an advantageous effect that compared with liquid crystal projectors using conventional lamps, that the number of times the lamp unit or the lamp is changed is reduced.

In Embodiment 2, a front-projection type image display apparatus is used as the image display apparatus that includes the lamp of the present invention. However, not limited to this, the present invention can be applied to, for example, a back-projection type image display apparatus.

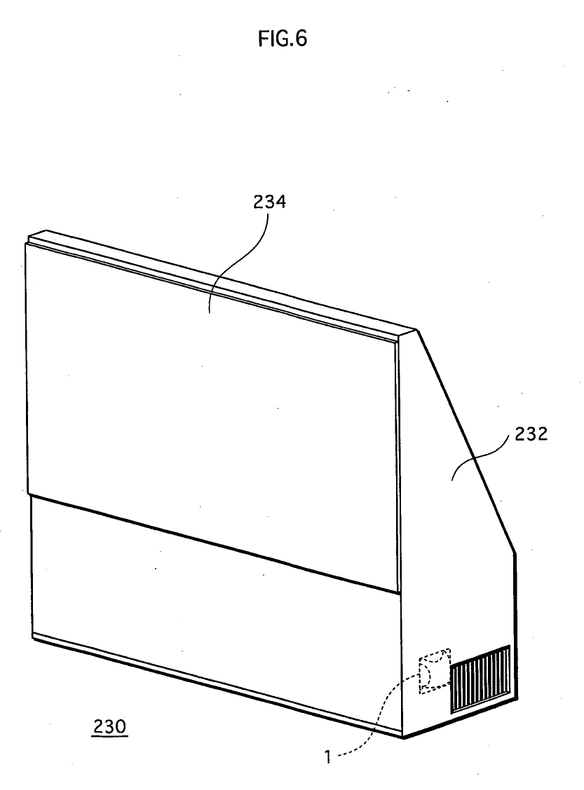

FIG. 6 is a perspective view of a back-projection type image display apparatus.

A back-projection type image display apparatus 230 includes: a cabinet 232; a screen 234 which, disposed on the front surface of the cabinet 232, displays images or the like; and a lamp unit 236 disposed inside the cabinet 232.

### <Modifications>

Up to now, the present invention has been described through the embodiments thereof. However, the present invention is not limited to the embodiments, but can be modified in a variety of ways. The following provides examples of such modifications.

### 1. Liquid Collecting Member

### (1) Construction

In the embodiments, the liquid collecting coil 43 is used as the liquid collecting member 41. However, coils with different constructions from the coil of the embodiment may be used instead. More specifically, while the liquid collecting coil 43 of the embodiments has three turns, the liquid collecting coil may have one turn, or two or four or more turns.

Also, in the embodiments, the liquid collecting coil 43 is singly wound, namely, is wound without overlapping in a direction perpendicular to the central axis of the coil. However, the liquid collecting coil may be formed by winding a wire, for example, doubly or triply in a direction perpendicular to the central axis of the coil.

In regards with the shape of the coil, the wire may be wound around the central axis of the coil to form the following shapes on a plane perpendicular to the central axis: (i) a circle, (ii) a polygon such as a triangle, (iii) an ellipse, or (iv) a combined shape of a circle and an ellipse. Also, each of these shapes may be formed with one turn or a plurality of turns, or by winding a wire for the turns to overlap each other in a direction perpendicular to the central axis of the coil. Furthermore, the electrode coils 37a and 37b may be wound around the electrode rod 35a including the electrode base parts.

In summary, in so far as the liquid collecting coil can collect the liquefied mercury, which is generated as the mercury vapor accumulates at the electrode base parts and is liquefied during a cooling period while the lamp is off, and can store the liquefied mercury without allowing it to drop, the liquid collecting coil is not limited specifically in terms of: diameter of the wire used for the coil; shape of the wire; diameter of the coil; the number of turns of the coil; the number of overlapping turns of the coil; measurement or the like.

Also, the liquid collecting member is not limited to a coil in shape, but may be any member in different shapes. For example, the liquid collecting member may be formed of one or more rings When a plurality of rings are used, the rings may be arranged to align along the electrode rod, or may be arranged to overlap in a direction perpendicular to the electrode rod. Each ring may be in a shape of (i) a circle, (ii) an ellipse, or (iii) a polygon such as a triangle.

When a coil or rings are used as the liquid collecting member, a plurality of turns of the coil or a plurality of rings may be arranged along the electrode rod and further arranged to overlap in a direction perpendicular to the electrode rod.

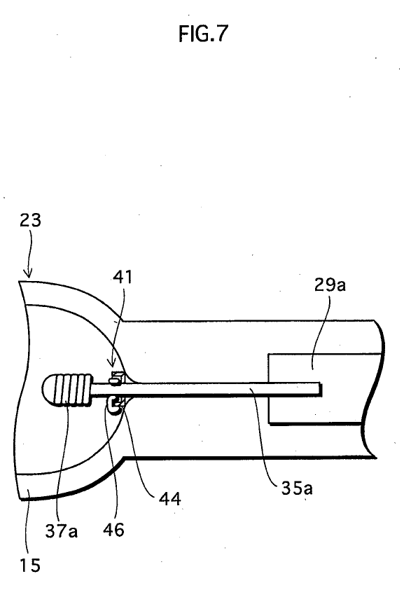

The liquid collecting member 41 may be a bottom-formed cylinder 44 shown in FIG. 7. In this example of the bottom-formed cylinder 44, the electrode rod 35a passes through the bottom wall, and the electrode rod 35a is fixed to the bottom wall.

Also, the liquid collecting member may be a bottomless cylinder. In this case, the electrode rod is fixed to the inner surface of the cylinder 44. The electrodes may be fixed to the bottom-formed or bottomless cylinders by welding as the electrode rods are fixed to the metal foils, or by, for example, caulking.

The cylinder used as the liquid collecting member 41 may be in any shape in the transverse cross section, and is not limited to the shape of a circle or a polygon such as a triangle. Furthermore, to increase the area of a cylinder part to which mercury is attached, and to improve the adhesiveness of the mercury to the cylinder, the surface of the cylinder may be made uneven, or a plurality of through holes may be formed in the side (except for the top and the bottom) wall of the cylinder.

### (2) Collecting Mercury

In the embodiments, the lamp 3 includes the liquid collecting member 41 for collecting liquefied mercury that is generated as the mercury vapor accumulates at the electrode base parts and is liquefied during a cooling period while the lamp is off. The liquid collecting member 41, however, also has a function to hold the mercury vapor as it is while it is attached to the electrode base parts during the cooling period, before it is liquefied. Therefore, the liquid collecting member 41 may also be referred to as a “holding member” that holds the mercury vapor that gathers and attaches to the electrode base part during the cooling period while the lamp is off, regardless of whether the mercury is vapor or has been liquefied.

It is considered that such a construction also produces the advantageous effect of decreasing the time required for the transition from the base discharge to the main discharge at the start of a lamp lighting. This is because even when the lamp is lighted before the gathered mercury vapor is liquefied, which may sometimes be the case, the time required for the transition is decreased if the gathered mercury vapor remains in the vicinity of the electrode base part.

From the above-stated point of view, it is apparent that there is no need to provide even a mercury holding member in so far as the lamp is constructed to keep the mercury in the vicinity of the electrode base part when a lamp lighting is started. That is to say, if an improved lamp has a construction in which a more amount of mercury gathers and attaches to the electrode base part during the cooling period while the lamp is off, than in the conventional lamps, the base discharge changes into the main discharge with less time in the improved lamp than in the conventional lamps.

For example, the improved lamp may have a construction for increasing the area of the surface to which mercury is attached. For example, the electrode rods may have an area expansion part for increasing the area of the surface to which mercury is attached. Such an area expansion part may be an uneven surface part of the electrode rods. Alternatively, the area expansion part may be the surface of the electrode rods that is formed in a manner such that the electrode rods are in a shape of a polygon in the transverse cross section.

Furthermore, through holes may be formed in the base part of the electrode rods such that mercury is held in the through holes, namely the through holes are used as the holding member for holding mercury. The through holes can be regarded as the area expansion part since they increase the area of the surface to which mercury is attached.

### (3) Material

In the embodiments, the material, such as tungsten, of the electrode parts 27a and 27b is used as the material of the liquid collecting member (holding member) . However, other materials such as molybdenum or W/Mo (tungsten/molybdenum) based cermet maybe used as the material of the liquid collecting member (holding member).

### (4) Position

In the embodiments, the liquid collecting member 41 is provided at the base part of each of the electrode parts 27a and 27b. However, the holding member (liquid collecting member) may be provided at the base part of one of electrode parts in a pair. Also, the holding member may be formed as a catch pan for storing mercury that attaches to the base part of one or both of electrode parts in a pair, and may be provided at the main tube part or the sealing parts.

### 2. Lamp

### (1) Type

The lamp described in the embodiments is a short-arc type having a short inter-electrode distance. However, the present invention maybe achieved as a lamp that has a long inter-electrode distance and includes the liquid collecting member, holding member, and/or area expansion part. Also, for example, the present invention may be achieved as a lamp of a single-ended type or a double-ended type that includes the liquid collecting member, holding member, and/or area expansion part.

The lamp described in the embodiments is what is called a high-pressure mercury lamp. However, the present invention is also applicable to a lamp that increases the vapor pressure in the discharge space when the lamp is started to be lighted, more specifically a metal halide lamp that uses a halide metal as the light-emitting material. The base discharge also occurs in a metal halide lamp at the start of the lighting. It is therefore possible to reduce the base discharge duration even in the metal halide lamp by providing the liquid collecting member of the present invention thereto. It is considered that also in the case of a metal halide lamp, filling xenon therein decreases the time required for the transition from the base discharge to the main discharge.

### (2) Electrode

In the embodiments, a pair of electrodes are disposed to align substantially in a straight line such that the tips thereof face each other with a distance in between. However, the arrangement of the pair of electrodes is not limited to this.

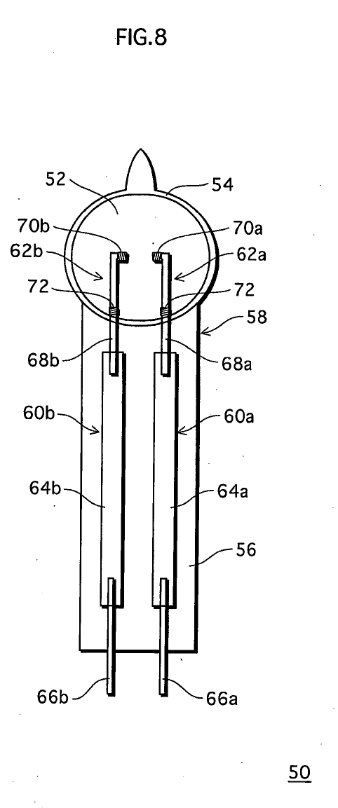

FIG. 8 shows a lamp that is different from the lamp of the embodiments in the direction in which the electrodes extend.

A lamp 50, as shown in FIG. 8, includes a discharge vessel 58 and electrode assemblies 60a and 60b. The discharge vessel 58 is composed of a main part 54, which has a discharge space 52 therein, and a sealing part 56 attached to the main part 54. The electrode assemblies 60a and 60b are hermetically sealed with the sealing part 56 such that the tips (electrode parts which will be described later) of the electrodes face each other with a distance in between in the discharge space 52. As is the case with Embodiment 1, the discharge space 52 is filled with mercury, rare gas, and halogen gas.

The electrode assembly 60a is composed of an electrode part 62a, a metal foil 64a, and an external lead 66a which are connected to one another in the stated order. Similarly, the electrode assembly 60b is composed of an electrode part 62b, a metal foil 64b, and an external lead 66b which are connected to one another in the stated order. In this example also, mainly the metal foils 64a and 64b are hermetically sealed with the sealing part 56. Also, the tips of the electrode assemblies 60a and 60b are the electrode parts 62a and 62b, and that the electrode parts 62a and 62b correspond to “electrodes” in the claims.

The external leads 66a and 66b extend to outside of the discharge vessel from the outer end of the sealing part 56. As is the case with Embodiment 1, the external leads 66a and 66b extend to outside of a reflecting mirror which is not illustrated.

The electrode parts 62a and 62b respectively include: electrode rods 68a and 68b whose tips are bent toward each other; and electrode coils 70a and 70b formed on the tips of the electrode rods 68a and 68b.

In the construction of this example, different from that in Embodiment 1, the electrode rods 68a and 68b extend in parallel with each other from the sealing part 56, and the tips of the electrode parts 62a and 62b face each other in the discharge space 52. The electrode rods 68a and 68b are bent at the tips toward each other substantially at 90 degrees such that the electrode parts 62a and 62b align substantially in a straight line to face each other. The distance between the electrode parts 62a and 62b, namely the inter-electrode distance is set to a range from 0.5 mm to 2.0 mm in the case of a short-arc type.

It should be noted here that in this modification example, parts of the electrode parts 62a and 62b that are exposed to the discharge space 52 and near the sealing part 56 are referred to as “base parts of the electrode parts 62a and 62b”, and correspond to “base parts of the electrodes” in the claims.

As is the case with Embodiment 1, a liquid collecting member is provided at each base part of the electrode parts 62a and 62b. The liquid collecting member 41 is, in this example, a liquid collecting coil 72 that is made by winding a wire to have a plurality of turns.

The liquid collecting coil 72 is, as is the case with Embodiment 1, formed of a wire that is made of the same material as the electrode rods 68a and 68b. The liquid collecting coil 72 is fixed to each of the electrode rods 68a and 68b by directly winding a wire around the electrode rods 68a and 68b or by welding a coil, which has been wound already, to the electrode rods 68a and 68b. The liquid collecting member may be a liquid collecting coil as in Embodiment 1, or may be a bottom-formed cylinder shown in FIG. 7, or may be any of the modifications described in “1. Liquid Collecting Member” of <Modifications>.

Up to now, only lamps have been described. However, each of the described lamps may be used in a lamp unit or used as a light source for an image display apparatus.

### (3) Driving Method

The lamp 3 in the embodiments is of an alternating-current driving type. However, the present invention is also applicable to a direct-current-driving-type lamp (a high-pressure mercury lamp, a metal halide lamp or the like). In this a case, the liquid. collecting member or holding member can be provided in the vicinity of the base part of the cathode electrode, or the area expansion part can be formed in the base part of the cathode electrode.

### 3. Lamp Unit

In the embodiments, the lamp unit 1 includes the glass member 9 as the reflecting mirror 5. However, the glass member may be omitted. Also, the glass member may be replaced with a lens member that functions as a lens.

Also, in the embodiments, the reflecting mirror as the reflecting member 7 is a dichroic reflecting mirror. However, not limited to this, the reflecting mirror for the present invention may be (i) a reflecting mirror having a reflecting surface on which aluminum is vapor-deposited, or (ii) a reflecting mirror using a metal.

### INDUSTRIAL APPLICABILITY

The present invention is applicable to an improvement in the lamp life that has been shortened due to the base discharge that occurs at the start of lighting.

1. A high-pressure mercury lamp, comprising:
a discharge vessel composed of a main body and a sealing part connected to the main body, the main body having inside a discharge space filled with mercury;
two electrodes that respectively extend into the discharge space from and are supported by the sealing part such that tips thereof face each other in the discharge space; and
a holding member operable to hold mercury that gathers, during a cooling period while lighting is off, in vicinities of base parts of the electrodes inside the discharge space.

2. The high-pressure mercury lamp of claim 1, wherein
the holding member is fixed to the base parts of the electrodes.

3. The high-pressure mercury lamp of claim 1, wherein
the holding member is a liquid collecting member operable to collect liquefied mercury which is generated as mercury vapor accumulates and is liquefied at the base parts.

4. The high-pressure mercury lamp of claim 2, wherein
the holding member is a liquid collecting member operable to collect liquefied mercury which is generated as mercury vapor accumulates and is liquefied at the base parts.

5. The high-pressure mercury lamp of claim 3, wherein
the liquid collecting member is made by winding a wire to have one or more turns.

6. The high-pressure mercury lamp of claim 4, wherein
the liquid collecting member is made by winding a wire to have one or more turns.

7. The high-pressure mercury lamp of claim 3, wherein
each electrode includes an electrode rod and an electrode coil that is provided at a tip of the electrode, and the liquid collecting member is provided on the electrode rod.

8. The high-pressure mercury lamp of claim 6, wherein
each electrode includes an electrode rod and an electrode coil that is provided at a tip of the electrode, and the liquid collecting member is provided on the electrode rod.

9. The high-pressure mercury lamp of claim 7, wherein
the liquid collecting member is provided separately from the electrode coil.

10. The high-pressure mercury lamp of claim 8, wherein
the liquid collecting member is provided separately from the electrode coil.

11. A high-pressure mercury lamp, comprising:
a discharge vessel composed of a main body and a sealing part connected to the main body, the main body having inside a discharge space filled with mercury; and
two electrodes that respectively extend into the discharge space from and are supported by the sealing part such that tips thereof face each other in the discharge space, wherein
base parts of the electrodes inside the discharge space have an area expansion part that has an increased area of a surface of the electrodes to which mercury is attached during a cooling period while lighting is off.

12. The high-pressure mercury lamp of claim 1, wherein
the discharge space is filled with xenon.

13. A lamp unit, comprising:
the high-pressure mercury lamp defined in claim 1; and
a reflecting mirror that reflects light emitted from the high-pressure mercury lamp.

14. An image display apparatus comprising the high-pressure mercury lamp defined in claim 1.
